(19) United States
(12) Patent Application Publication
(10) Pub. No.: US 2020/0293560 A1
(43) Pub. Date: Sep. 17, 2020

(54) Matching Inventors System and Method Thereof

(71) Applicant: David & Raymond Patent Firm, Monterey Park, CA (US)

(72) Inventors: Raymond Y. CHAN, Monterey Park, CA (US); Rihui CHEN, Shenzhen (CN); Xueguang DONG, Shenzhen (CN); Tiaowan LIU, Shenzhen (CN); Wei DU, Shenzhen (CN); Xiaoxiao DUAN, Shenzhen (CN)

(21) Appl. No.: 16/796,923

(22) Filed: Feb. 20, 2020

(30) Foreign Application Priority Data
Feb. 20, 2019 (CN) 2019101263079

(51) Int. Cl. G06F 16/28

(52) U.S. Cl. CPC G06F 16/288; G06Q 50/184

(57) ABSTRACT

A matching inventors method, for confirming the contribution made by each inventor can be conveniently, includes steps of:
I. Obtaining one of claims form a specification;
II. Translating said claim to obtain a discriminated code which presents said claim; and
III. Pairing said discriminated code with at least one inventor preset in at least one inventors database to determine the contribution of said inventor to said claim.

### CROSS REFERENCE OF RELATED APPLICATION

This is a non-provisional application that claims the benefit of priority under 35U.S.C.§ 119 to a Chinese application, application number 2019101263079, filed Feb. 20, 2019.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of the Invention

The present invention relates to filling patent, and more particularly to a matching inventors system and a matching inventors method.

### Description of Related Arts

During filling patents, especially in a firm or a work group, there are more than one inventors. For the readers of a published patent or a patented file, the inventor's name can only be found in the inventor section which is difficult to notice the contribution made by specific inventor. Obviously, different inventors contribute differently to the entire invention. One of the inventors may have come up with the whole concept of the invention, and some inventors might have better specific subject matter, and some inventors might have improved others work, and some inventors might have solution of other new technical problems.

Matching the claims with the inventors is the basis of identifying ownership of patent rights. It to be able to determine whether the inventor or the firm has right to own the patent right in accordance with the law or contracts by confirming whether the inventors' behavior is his job or non-job.

It is very important to use the patent right after granted. And also it can encourage people or employee to invent new things in a working group, once there are contracts for rewarding the inventors according to working effort they made. If the patent rights are matched with the inventors respectively, who has how much bonuses and rewards are confirmed.

Furthermore, after the inventors become the patentee, the contribution of each of the inventors can be used to have claims better dispensed and make proper contract with the firm.

The inventors' work are ultimately expressed on the application documents which comprises abstract, specification, claims, or drawings. Patent application documents are usually written by patent agents who will express the inventors' work and creation in professional language to make patent documents standard for exam of USPTO.

There are usually more than one solutions in the patent application documents. Obviously, it is very time-consuming and labor-intensive for the inventors to confirm the attribution of each solution one by one after filling or patenting.

When inventions is the result of several independent teams in cooperation, the work of other inventors is unclear between teams or groups. Some inventors' work may be duplicate, so it needs to be honest discussed about the ownership of the solutions or claims.

### SUMMARY OF THE PRESENT INVENTION

The invention is advantageous in that it provides a matching inventors system and method thereof, wherein the contribution made by each inventor can be conveniently confirmed by the matching inventors system.

Another advantage of the invention is to provide a matching inventors system and method thereof, wherein the contributed subject matter made by each inventor can be automatically confirmed by the matching inventors system.

Another advantage of the invention is to provide a matching inventors system and method thereof, wherein the matching inventors system is cable of matching the inventor with the contributed claims.

Another advantage of the invention is to provide a matching inventors system and method thereof, wherein the matching inventors system is cable of matching the inventor with the contributed claims according to an inventor database, wherein the inventor is matched with the contribution of the subject matter.

Another advantage of the invention is to provide a matching inventors system and method thereof, wherein the matching inventors system is capable of comparison of the inventor database to the claims to match the inventor with the inventor database.

Another advantage of the invention is to provide a matching inventors system and method thereof, wherein the matching inventors system is capable of processing the claims to facilitate subsequent comparisons.

Another advantage of the invention is to provide a matching inventors system and method thereof, wherein the matching inventors system is capable of translation of the claims with a database, then comparing the inventor database to the claims to match the inventor with the inventor database.

Another advantage of the invention is to provide a matching inventors system and method thereof, wherein the matching inventors system is capable of translation of the specification corresponding to the claims with a database, then comparing the inventor database to the claims to match the inventor with the inventor database.

Another advantage of the invention is to provide a matching inventors system and method thereof, wherein according to the ownership of a dependent claim, the matching inventors system is capable of matching the other dependent claim depending on the dependent claim with the inventor.

Another advantage of the invention is to provide a matching inventors system and method thereof, wherein according to the ownership of a depended claim, the matching inventors system is capable of matching the other dependent claim depending on the depended claim with the inventor.

Additional advantages and features of the invention will become apparent from the description which follows, and may be realized by means of the instrumentalities and combinations particular point out in the appended claims.

According to the present invention, the foregoing and other objects and advantages are attained by a matching inventors method, comprising steps of:

S1. obtaining a claim;

S2. deciding whether the claim is matched with at least partial content inside at least one inventor database, wherein the inventor database comprises at least one inventor and corresponding contribution made by the inventor; and

S3. If so, pairing the corresponding inventor with the claim according to the matched inventor with the contribution inside the inventor database.

According to an embodiment of the present invention, the method further comprises a step of:

S4. Repeating steps of S1 to S3 until all claims are matched with the inventor.

According to an embodiment of the present invention, the method further comprises a step of:

S5. Analyzing the claim to obtain a discriminated code, wherein the step S5 is proceed between the step S1 and step S2, and step S2 is implemented as:

determining whether the discriminated code is matched with at least partial content inside at least one inventor database, wherein the content is paired with the inventor inside the inventor database.

According to an embodiment of the present invention, the method further comprises the steps of:

translating the discriminated code to obtain a translation result according to an interpretation database, wherein the translation result is an analyzing result.

According to an embodiment of the present invention, the method further comprises the steps of:

Translating the claim to obtain a translation result according to an interpretation database, wherein the step S2 is implemented as:

determining whether the translation result is matched with at least partial content inside at least one inventor database, wherein the content is paired with the inventor inside the inventor database.

According to an embodiment of the present invention, in the method, the translation result is analyzed to obtain a discriminated code, wherein the step S2 is implemented as:

determining whether the discriminated code is s matched with at least partial content inside at least one inventor database, wherein the content is paired with the inventor inside the inventor database.

According to an embodiment of the present invention, in the method, identifying one of base databases corresponding to the field of the claims to form the interpretation database.

According to an embodiment of the present invention, in the method, pairing the claim with a specification comprising the claims, a user database is formed, and forming the interpretation database by the user database and the base database.

According to an embodiment of the present invention, in the method, receiving a user input interpretation corresponding to the claim to form an individualized database; and forming the interpretation database by the user database, the individualized database and the base database.

According to an embodiment of the present invention, in the method, receiving user input interpretation corresponding to the claim to be a part content of the individualized database.

According to an embodiment of the present invention, in the above method, pairing the claim with a specification comprising the claims to generate a pairing result, wherein the pairing result is at least part of the interpretation database.

According to an embodiment of the present invention, the method further comprises the step of receiving a user's correction to match of the claim and the corresponding inventor.

According to an embodiment of the present invention, the method further comprises the steps of:

If the claim does not match with the inventors database and the claim is a dependent claim, determining whether the independent claim of the dependent claim is matched with at least partial content inside at least one inventor database, and

If so, matching the inventor of the independent claim with the dependent claim according to the inventor corresponding the content inside the inventor database.

According to an embodiment of the invention, the method further comprises the steps of:

If the claim does not match the inventor database and the claim is a dependent claim, determining whether a depended claim of the dependent claim is matched with at least partial content inside the inventor database;

If the depended claim is not matched with the inventor database and the depended claim is depending on the other claim, determining whether the claim depended by the depended claim is matched with at least partial content inside the inventor database; and

If so, matching the inventor of the claim depended by the depended claim with the dependent claim according to the inventor corresponding the content inside the inventor database.

According to an embodiment of the invention, the method further comprises the steps of:

If the claim does not match the inventor database and the claim is claim is a depended claim, determining whether a dependent claim depending on the depended claim is matched with at least partial content inside the inventor database; and

If so, matching the inventor with the dependent claim with the depended claim according to the inventor corresponding the content inside the inventor database.

According to an embodiment of the invention, the method further comprises the steps of:

If the claim does not match the inventor database and the claim is claim is a depended claim, determining whether a dependent claim depending on the depended claim is matched with at least partial content inside the inventor database;

If the dependent claim is not matched with the inventor database and the other claim depending on the depended claim, determining whether this other claim is matched with at least partial content inside the inventor database; and

If so, matching the inventor with the dependent claim with this other claim depending on the depended claim according to the inventor corresponding the content inside the inventor database.

According to the present invention, the foregoing and other objects and advantages are attained by a matching inventors system, comprising:

an acquiring unit, wherein the acquiring unit is configured to obtain a claim;

a decision unit, wherein after determining whether the claim is matched with at least partial content inside the inventor database, the decision unit generates a pairing result, wherein the content inside the inventor database is paired with the inventor; and

a matching unit, wherein when the pairing result of the decision unit is affirmative, the matching unit pairs the claim with the inventor according to the matched content inside the inventor database.

According to an embodiment of the invention, the matching inventors system further comprises an analysis unit, wherein the analysis unit is respectively communicatively connected to the acquiring unit and the decision unit, wherein the analysis unit analyzes the claim to obtain a discriminated code according to the claim obtained by the acquiring unit, wherein the decision unit determines whether the discriminated code is matched with at least partial content inside the inventor database.

According to an embodiment of the invention, the analysis unit comprises an extraction module and a translation module, wherein the extraction module is communicably connected to the acquiring unit, and the translation module is communicably connected to the decision unit, wherein the extraction module obtains one of the discriminated code form the claim obtained from the acquiring unit, wherein the translation module translates the discriminated code based on an interpretation database to obtain a translation result, wherein the decision unit determines whether the translation result is matched with at least partial content inside the inventor database.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a matching inventors method according to a first preferred embodiment of the present invention.

FIG. 2 is a schematic view of the matching inventors method according to the above preferred embodiment of the present invention.

FIG. 3 is a schematic view of the matching inventors method according to the above preferred embodiment of the present invention.

FIG. 4 is a schematic view of the matching inventors method according to the above preferred embodiment of the present invention.

FIG. 5 is a schematic view of the matching inventors method according to the above preferred embodiment of the present invention.

FIG. 6 is a schematic view of the matching inventors method according to the above preferred embodiment of the present invention.

FIG. 7 is a schematic view of a matching inventors system according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

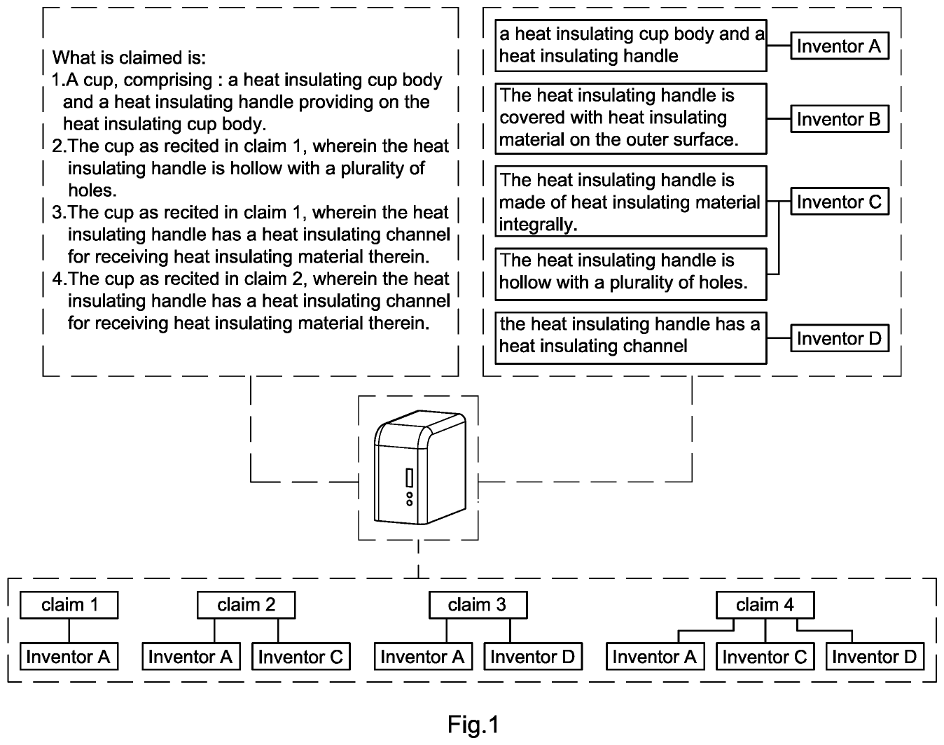

According to FIG. 1, a matching inventors method of a preferred embodiment of the present invention is illustrated.

The matching inventors method can be used to automatically confirm and pair the inventors with the contribution made by the inventor to facilitate the patent right ownership and distribution.

Patent application or patent filing paper mainly has several documents, like the specification and drawings, and the specification mainly has five sections, as the title part, the background part, the summary part, the embodiments part and the claims part. The claims play a very important role. Article 59, the first paragraph of in “Patent Law of the People's Republic of China” stipulates that “the protective scope of the invention patent or the utility patent is in its claims and their equivalents”. This indicates that the role of the claims is to determine the scope of protection of patent applications and patents. Article 26, paragraph 3 of “Patent Law of the People's Republic of China” stipulates that “the specification should clearly and completely describe the invention or utility invention, which can be achieved by those skilled in the art. The drawings and description of the specification can be used to interpret the claims”. Article 35 U.S.C. 112(b) is that “The specification shall conclude with one or more claims particularly pointing out and distinctly claiming the subject matter which the inventor or a joint inventor regards as the invention.” The invention is explained as what is the in claim in Markman v. Westview Instruments, Inc., 517 U.S. 370(1996).

So by confirmation of ownership of single claim to match the inventors contributed to make the claims, it will facilitates the exercise of power. Even before patent filling, the inventors can have contracts to settle the ownership or distribution of the profit according to paired inventor and contribution matched through the matching inventors method of the present invention.

The claims part of the specification comprises one or more claims, which covers one or more embodiments. When the number of inventors is multiple, each inventor contributes differently to each claim. For example, there are several claims which are claim 1, claim 2, and claim 3, and claim 2 is depended on claim 1, and the claim 3 is depended on claim 1. Inventor A may be have contributed to claim 2. Inventor B may be have contributed to claim 3. And claim 1 is from Inventor A and B. So the inventors of claim 1 is Inventor A and B, but the inventor of claim 2 is Inventor A and the inventor of claim 3 is Inventor B.

Furthermore, a patent document from the birth to the filing of an invention, which needs to go through an important part of handled by a patent attorney. Patent agent usually has a background in technology and law, with a strong logical thinking and higher word processing and communication skills, and a professional way to draft the patent documents in kind of fully understanding of the inventors based on the conception.

In this diligence, the technical disclosure paper is an important communication between the patent agent and the inventors. The technical disclosure paper is provided to patent attorney by customers for patent agents understanding this invention. Customers typically provide multiple technical solutions in the inventor database. And the patent agent drafts the application documents based on the technical disclosure paper and communicates with customers on specific issues.

When there are several inventors, the customer can specify the contents corresponding to the inventors to facilitate drafting work. Of course, the correspondence relationship may be confirmed inside the technical disclosure paper and the inventors during communication

By the matching inventors method, the each claims can be conveniently confirmed by an inventor database to help of recognizing bonuses and rewards for the inventors based on contributions made by the each inventor.

It will be understood that the inventors database of the invention is not limited to a file called “technical disclosure paper” from the customer. The communicated messages, emails, or experimental records provided by the inventor, for example notebooks, other records and documents of whole process of the invention can prove contributions of the inventor. The inventors database can not limited in words, it may be video and other recorded information.

Furthermore, the each of the claims consists of two parts, which are a preamble and a body of claim to clearly point out subject matter of the invention or utility model invention and the essential technical features shared by the subject matter. The independent claim is a name for the subject matter in the preamble. The dependent claim is a reference part with the name and number of depended claim. The body of claim is a feature part for an independent claim, which uses the phrase “comprising” or similar terms to indicate that the invention or utility model differs from the closest prior art technical features. Together with the features recited in the preamble, the scope of the invention or the utility model is claimed, and a dependent claim is an additional technical feature of the invention or utility model. The dependent claim is depending on preceding claim or claims.

The embodiment of the present invention provides a matching inventors method, wherein the method comprises the following steps:

S1. obtaining a claim;

S2. deciding whether the claim is matched with at least partial content inside at least one inventor database, wherein the inventor database comprises at least one inventor and corresponding contribution made by the inventor; and

S3. If so, pairing the corresponding inventor with the claim according to the matched inventor with the contribution inside the inventor database.

Specifically, firstly obtaining from the claims, for instance the claim 1, and then comparing at least one of inventors database with the claim, in order to decide whether there is a match inside contents of the database invention to the claim.

It is worth to mention that, the inventors database is typically written by the inventors, and then provided to the patent agent. Before writing the start of the writing of the inventor database, the patent attorney should prompt the inventors to mark the contents of his corresponding creation to indicate the name of the inventor. Of course, this work can also be done during the integration process of the inventor database. The number of the inventors database is not limited to one. It may be a plurality of inventors database for each inventor to have one and the patent agent reintegrate the inventors databases.

Furthermore, it is capable of searching in the inventors database with the claim to determine whether the claim is matched with the content of inventors database

It is to be understood that the claims and the inventors database content may be matched one to one, may be substantially matched. For example, claim 1: a cup, comprising: a handle wherein the handle is made of insulating material. The searched result of the inventors database is a cup made of an insulating plastic. It does not correspond exactly between the claim 1 and the inventors database, but can be matched with each other therebetween.

Furthermore, after matching the claim and the inventors database, generates a matching rate. When the matching rate is over a predetermined value, a pairing result is obtained that both match each other to confirm the inventors. When the matching rate is lower than a predetermined value, a pairing result is obtained that both do not match each other, so that other content of the inventors database continues to match the inventors to finish the claims.

After the corresponding content in the inventors database matching with the claim found, based on the content in the inventors database matching the inventor, at least one inventor corresponding to the content is obtained. The inventor is confirmed as the claim's inventor to have clearly ownership of the claim and paired the contribution made by the inventor.

In this way, it is beneficial for the subsequent management of the patent application documents or the patent documents, which is beneficial to the patent rights or the division of profit.

The claims may be presented in an electronic document, it may correspond to the vicinity standard of the inventors of the corresponding claims.

Furthermore, the matching inventors method further comprise the steps of:

S4. Repeating steps of S1 to S3 until all claims are matched with the inventor.

It will be understood that for a specification with a number of claims may be attributed the claims from the first claim to be started, or from the last one claim to be started, or from the middle of any one of claims to be started.

For the processing order of a plurality of claims may be processed in order, or in reverse order, or according to a specified order, or in a predetermined order.

For example, in a specification what is claimed is:

1, A comprising B and C.

2, A as recited in claim 1, further comprising D.

3, A as recited in claim 1, further comprising E.

4. A as recited in claim 2, further comprising E.

It will be understood that, for claim 1, the scope of invention is a A comprising B and C.

For to claim 2, the scope of invention is A comprising B, C and D.

For to claim 3, the scope of invention is A comprising B, C and E.

For to claim 3, the scope of invention is A comprising B, C, D, and E.

For example, in the step S1, claim 2 is obtained, which means A comprising B, C and D, and not just “D.”

For example, in a specification what is claimed is:

1. A cup, comprising: a heat insulating cup body and a heat insulating handle, the handle is disposed on the heat insulating cup body.

2. The cup as recited in claim 1, wherein the heat insulating handle is a hollow, wherein the heat insulating handle has a plurality of holes.

3. The cup as recited in claim 1, wherein the heat insulating handle has a heat insulating channel for receiving heat insulating material.

4. The cup as recited in claim 2, wherein the heat insulating handle has a heat insulating channel for receiving heat insulating material.

It may be matched from claim 1 to confirm, based on the inventors database and to be aware of the claim 1 “heat insulating cup body” and “heat insulating handle” matching with the inventor A. Then the claim 2 is confirmed, based on the inventors database to be known technical solution in the claim 2 corresponds to the inventor C. And the claim 2 is depended on claim 1, so the technical solution in claim 2 is owned by inventor A. Then the claim 3 is confirmed, based on the inventors database to be known technical solution in the claim 3 corresponds to the inventor D. And the claim 3 is depended on claim 1, so the technical solution in claim 3 is owned by inventor A. Then the claim 4 is confirmed, based on the inventors database to be known technical solution in the claim 4 corresponds to the inventor D. And the claim 4 is depended on claim 2, so the technical solution in claim 2 is owned by inventor A and C. In this way, ownership of the claims is paired.

Furthermore, the method, further comprises a step of S5:

Analyzing the claim to obtain a discriminated code, wherein the step S5 is proceed between the step S1 and step S2, and step S2 is implemented as:

determining whether the discriminated code is matched with at least partial content inside at least one inventor database, wherein the content is paired with the inventor inside the inventor database.

The discriminated code is the different content from the other claims of the claim. The discriminated code is a distinguishing feature or at least one key word in the body of claim of the claim.

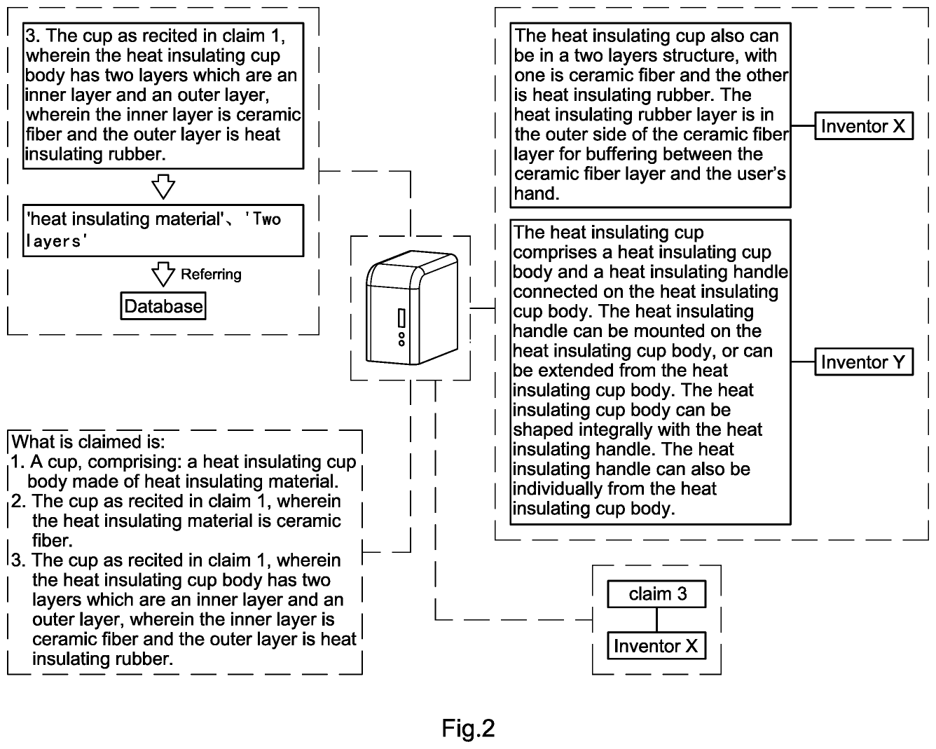

For example, in FIG. 2, in a specification what is claimed is:

1. A cup, comprising:

a heat insulating cup body made of heat insulating material.

2. The cup as recited in claim 1, wherein the heat insulating material is ceramic fiber.

3. The cup as recited in claim 1, wherein the heat insulating cup body has two layers which are an inner layer and an outer layer, wherein the inner layer is ceramic fiber and the outer layer is heat insulating rubber.

After obtaining claim 3, analyzing the technical features of claim 3 to obtain the difference, “the heat insulating cup body has two layers which are an inner layer and an outer layer, wherein the inner layer is ceramic fiber and the outer layer is heat insulating rubber”, or analyzing to obtain the keywords “two layers, insulating material”. And then based on the difference of the keywords of the claim 3, matching inventors according to the inventors database.

Furthermore, the matching inventors method further comprises the following steps:

translating the discriminated code to obtain a translation result according to an interpretation database, wherein the translation result is an analyzing result.

Specifically, implementation in the Patent Law of the People's Republic of China, the claims should be based on the description, clearly and concisely define the scope of patent protection. The claims are difficult to be quickly appreciated for an untrained reader. Because on the one hand, it needs to make some generalizations on technical solutions to cover as much as possible. On the other hand, it requires a brief statement which has difference between the general expression

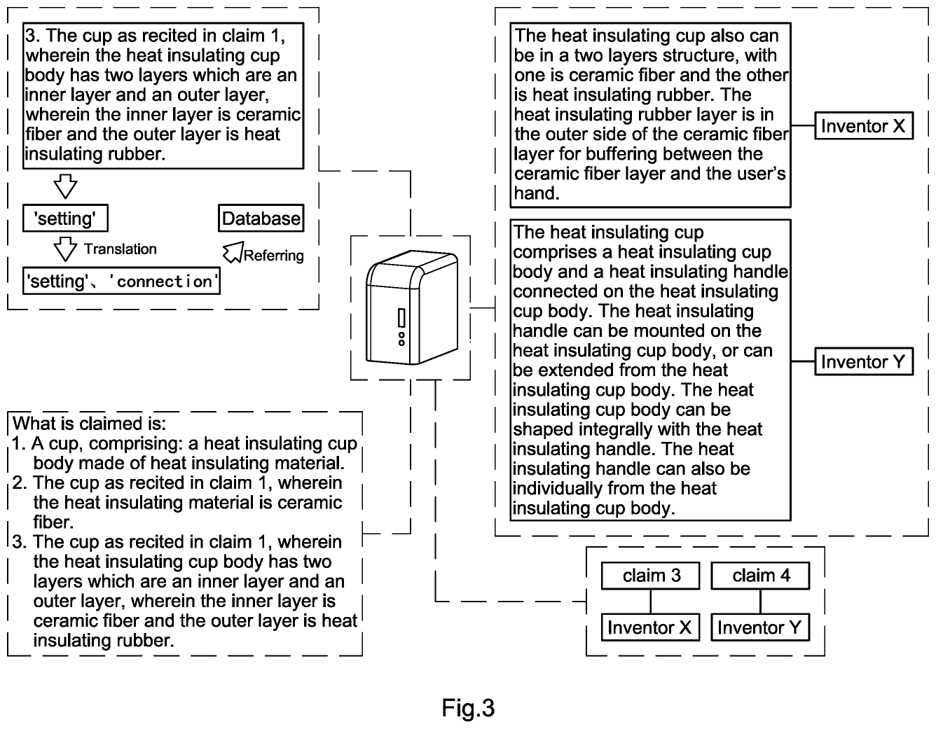

The interpretation database may be a specialized database of patents which generally collected the expression of the corresponding interpretation in the claims and in specification. For example, as shown in FIG. 3, the expression in the claims is “a handle providing on the cup body, wherein the handle is made of a heat insulating material”, and the word “providing” is analyzed to be used as the discriminated code, which may correspond to a plurality of words such as “connected”, “formed”, “installed”, “extended”, and the like.

In contrast to search inside the interpretation database with “providing” can obtain an interpretation results of “connecting”, “forming”, “mounting,” and “extending” and the like, and the interpretation result is the analysis results. The analysis result is compared with the inventors database to determine whether the analysis result and the present inventors database are matched. If so, the inventors are confirmed by the matched content.

Furthermore, it will be understood that the analysis result of the discriminated code can comprise a plurality of words, such as “connected”, “formed”, “extended” and the like. The analysis result or the discriminated code matched with the inventors database do not represent one to one correspondence between analysis result or the discriminated code with the inventors database. The analysis result or the discriminated code as long as may be the partially identical, and not necessarily the 100% similarity of the words, for example, “rotation” and “stirring” may be also considered to be matched.

During matching inside the inventors database, the match rate and matching method can be set in advance, for example, reaches a certain rate of coincidence between the two can be regarded as the success of matching. For example, the analysis result comprises five phrases, wherein three phrases in the technical disclosure paper, it regarded as the success of matched. If only two phrases in the technical disclosure paper, it regarded as not matched.

Furthermore, in some embodiments of the present invention, it is based on the field of claims to corresponding to the interpretation database which translates the discriminated code to obtain the translation result, wherein the translation results are taken as the analysis result.

In the present embodiment, the field of the claims is daily necessities. The translation result is obtained based on possible meanings inside the interpretation database of daily necessities corresponding to “providing”. The translation result is used as the analysis result, and then the analysis result is determining the inventor inside the inventor database.

For example, the claims further comprising a claim 4, as follows:

4, The cup as recited in claim 1, wherein the cup further comprises a processor and a communication device, wherein the communication device is placed on the processor.

In this claim, the communication device is provided on the processor. If the inventor database only have “placed” corresponding to an inventor, then the claim 4 can be based on the inventor database to match corresponding inventor.

The elements claimed in claim 3 and claim 4 are not belong to the same field. The “providing” in the claim 3 belongs to the field of machinery, and the “placed” in the claim 4 belongs to the field of communication. In the communication field, “providing” belongs an upper concept to “placed”. The communication device may be provided to the processor in a manner of placing within the processor, or may be by a wireless manner to be placed with the processor. Furthermore, the analysis result of the claims can be matched with one of the technical solutions in the inventor database, and can also be matched with a plurality of the technical solutions. When the technical solutions are belong to the same inventor, the inventor is the matched inventor corresponding to the claims. When the technical solutions does not belong to the same inventor, all inventors can be the matched inventor corresponding to the claims, or some of the inventors are the matched inventors corresponding to the claims.

For example, in a patent application documents, what is claim is:

1. A comprising B and C.

2. The A as recited in claim 1, further comprising D.

3. The A as recited in claim 2, further comprising E.

4. The A as recited in claim 2, further comprising F.

The inventor of claim 2 is Alfa. The inventor of claim 3 is Alfa and Bravo. The inventor of claim 4 is Alfa and Charlie.

In a granted application file, claim 1 is that A comprising B, C, D, and E.

In a published application file, claim 1 is that A comprising B, C, D, and F.

It can be considered in a way that technical features D did little for allowance. Then the inventor of claim 1 of the granted application file can only be Bravo. The inventor of claim 1 of the published application file can only be Charlie. Whether the inventor Alfa contributes to the corresponding claims requires further discussion.

Therefore, the matching inventors method further comprises the following steps:

receiving a user's correction to match of the claim and the corresponding inventor, in order to modify and re-confirm the inventors.

According to another embodiment of the present invention, furthermore, the step S1 further comprises the following steps:

translating the claim to obtain a translation result according to an interpretation database, wherein the step S2 is implemented as:

determining whether the translation result is matched with at least partial content inside at least one inventor database,

In particular, the claims need to briefly, clearly express the inventions, which have a special expression way, by at least one of the interpretation database translating the claims into a more clear and easy to understand expression to facilitate subsequent determination and comparison.

For example, in a claim of a word “heterocyclic compound material”, but in the inventors database can not be matched to a “heterocyclic compound material”. By a chemical related database, the “heterocyclic compound material” refers to a molecule containing heterocyclic structure of the organic compound, ring-constituting atoms in addition to carbon atoms, but also having at least one hetero atom. Common “heterocyclic compound” is furan, thiophene, pyrrole, thiazole, imidazole, pyridine, pyrazine, pyrimidine, pyridazine, indole, quinoline, pteridine, or acridine. The translation of the interpretation database can obtain the analysis result. And then, based on the analysis result, find in the inventor database whether there is content matching the analysis result, thereby increasing the probability of matching, thereby facilitating accuracy and feasibility.

According to another embodiment of the present invention, the step S1 further comprises the following steps:

Translating the claim to obtain a translation result according to an interpretation database, wherein the step S2 is implemented as:

determining whether the translation result is matched with at least partial content inside at least one inventor database, wherein the content is paired with the inventor inside the inventor database.

In particular, the claims need to briefly, clearly express the inventions, which have a special expression way, by at least one of the interpretation database translating the claims into a more clear and easy to understand expression to facilitate subsequent determination and comparison.

For example, what is claimed is: 1, A cup, comprising a cup body, a cup cover and a handle, wherein the cup body has a receiving chamber, wherein the cup cover is for covering an opening of the receiving chamber, wherein the handle is provided in the cup, wherein the cup cover is made of plastic material.

After translation, the obtained translation result may be that a cup comprising a cup body, a cup cover and a handle, and the material of cup cover has allowable stress range of A %˜B % of the material, wherein the translation source of plastic material corresponds to a specification of the claims. In other words, the description of the specification can also be used as the interpretation database or is the part of interpretation database.

Furthermore, the analysis of the translation result is to obtain the discriminated code, and the discriminated code in this example is “allowable stress range of A %˜B % of the material”. As for the cup, the prior art of cups already comprises cup body, the cup cover and the handle, so the technical feature of “allowable stress range of A %˜B % of the material” may be a distinguishing technical feature from the prior art.

It will be understood that the interpretation of database may comprise a plurality of basic database, for example, from on the respective subjects or in the technical field of the data repository, for example, machinery or the computer art. It is worth to mention that, based on the specification and the claims, it may invoke a corresponding interpretation database to translate the claim.

The interpretation database may also has the specification corresponding to the claims. According to Patent Law, the specification and of the drawings can be used to interpret the claims. The specification can be used to interpret the claims.

Patent Attorney may explain the words or the specialized vocabulary inside the specification correspondingly, to allow the reader can be more clearly understood the claims. Patent agents may also use a self created word in claims, and has definition of the meaning in specification which is like a dictionary. The specification can be used as a user database, wherein the user database is at least a part of the interpretation database.

The interpretation database may also comprise user's input, i.e., the user can input an individualized database for explanation of the claims, wherein the individualized database is at least a part of the interpretation database.

When the claim or the distinguishing code of the claim has different interpretation inside the basic database, the individualized database and the user database, a translation result is generated based on the weight of the basic database, the individualized database and the user database. Of the weight of the basic database, the individualized database and the user database can be defined by user, for example, when the interpretation of the basic database, the individualized database and the user database are different, the user database can be preferably used or the individualized database and the user database can be simultaneously use.

Furthermore, the matching inventors method comprises the following steps:

Identifying a basic database from a plurality of base databases corresponding to the technical field of the claims to generate an interpretation database.

It will be understand that the technical field of claim can be identified by the title or the specification. For the patent application document, a field part of the specification is identified directly. For the patent published document, the classification located by the examiner can be used to identify the field of claims.

The basic database may be a textbook, literature materials in the technical field, and the like.

According to an embodiment of the present invention, the matching inventors method may further comprise the following steps of:

Forming a user database according to a specification of the claims; and

Forming the interpretation database according to the user database and the basic database.

According to an embodiment of the present invention, the matching inventors method may further comprise the following steps of:

Receiving a user input corresponding to the claims as an interpretation to be as a individualized database; and

Generating an interpretation database based on the basic database, the user database and the individualized database.

According to an embodiment of the invention, the matching inventors method further comprises the steps of:

If the claim does not match the inventor database and the claim is a dependent claim, determining whether a depended claim of the dependent claim is matched with at least partial content inside the inventor database;

If so, matching the inventor of the claim depended by the depended claim with the dependent claim according to the inventor corresponding the content inside the inventor database.

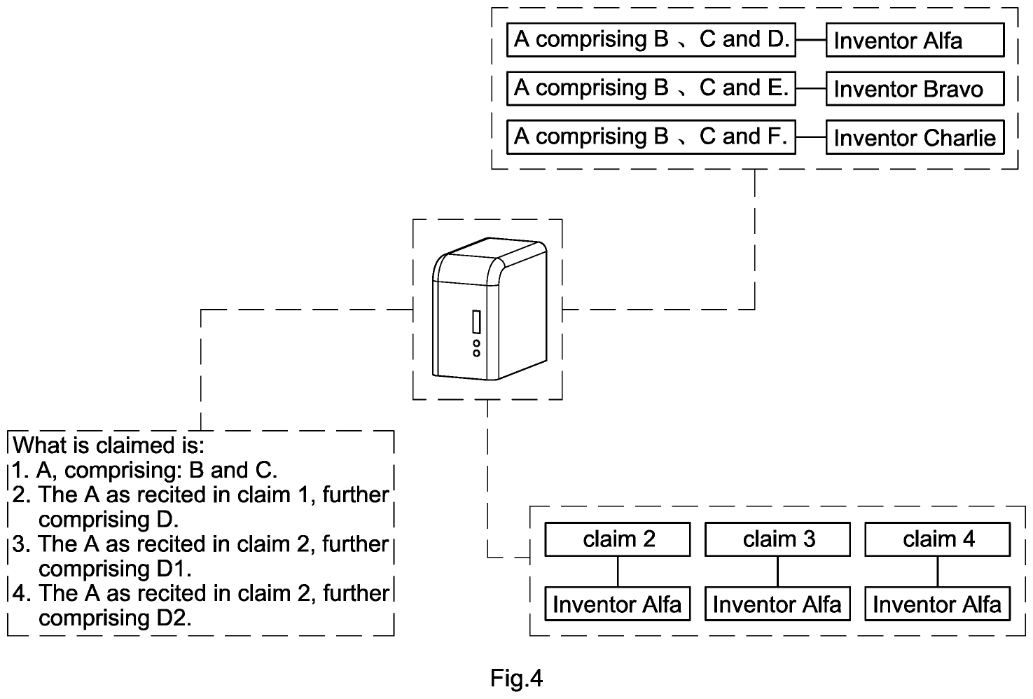

For example, so shown in FIG. 4, What is claimed is:

1. A, comprising: B and C.

2. The A as recited in claim 1, further comprising D.

3. The A as recited in claim 2, further comprising D1.

4. The A as recited in claim 2, further comprising D2.

The D1 claimed in claim 3 can not matched with the inventors database, and the claim 2 is a dependent claim, wherein claim 3 is depending on the claim 2. And feature D recited in claim 2 is matched with the inventors database. For example, the final confirmation of the inventor of claim 2 is Alfa, so the inventor of claim 3 is matched as Alfa, because D1 is a reasonable extension of the technical feature D.

Furthermore, according to an embodiment of the present invention, the matching inventors method may further comprise the following steps of:

If the claim does not match the inventor database and the claim is claim is a depended claim, determining whether a dependent claim depending on the depended claim is matched with at least partial content inside the inventor database;

If the dependent claim is not matched with the inventor database and the other claim depending on the depended claim, determining whether this other claim is matched with at least partial content inside the inventor database; and

If so, matching the inventor with the dependent claim with this other claim depending on the depended claim according to the inventor corresponding the content inside the inventor database.

Furthermore, according to an embodiment of the present invention, the matching inventors method may further comprise the following steps of:

If the claim does not match the inventor database and the claim is claim is a depended claim, determining whether a dependent claim depending on the depended claim is matched with at least partial content inside the inventor database; and

If so, matching the inventor with the dependent claim with the depended claim according to the inventor corresponding the content inside the inventor database.

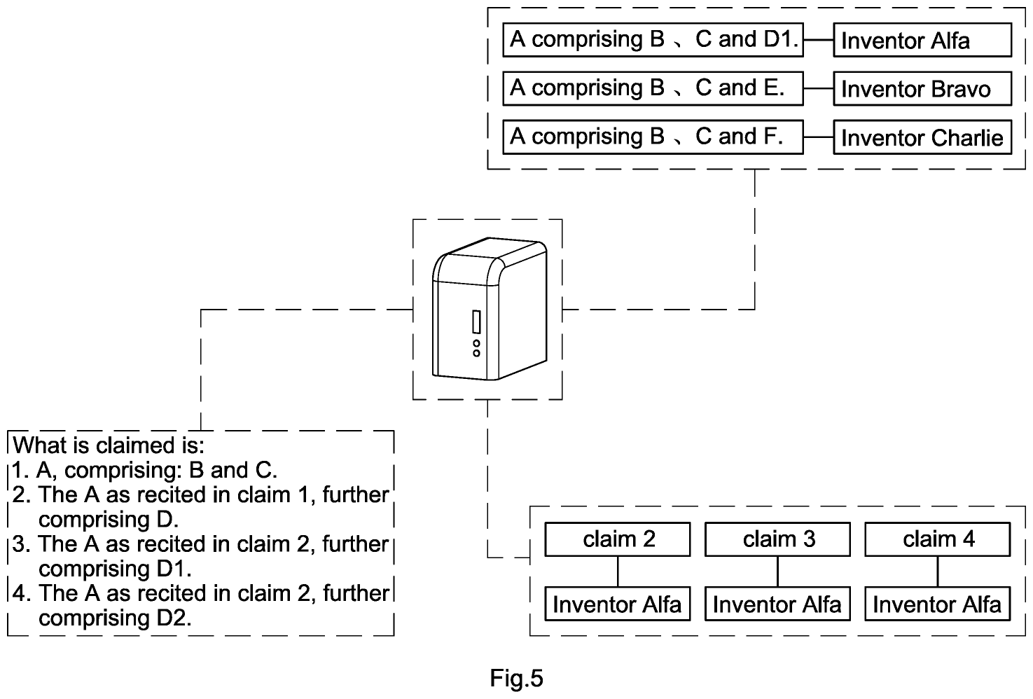

For example, so shown in FIG. 5, What is claimed is:

1. A, comprising: B and C.

2. The A as recited in claim 1, further comprising D.

3. The A as recited in claim 2, further comprising D1.

4. The A as recited in claim 2, further comprising D2.

The D claimed in claim 2 cannot matched with the inventors database, and the claim 3 is a dependent claim, wherein claim 3 is depending on the claim 2. And feature D1 recited in claim 3 is matched with the inventors database. For example, the final confirmation of the inventor of claim 3 is Alfa, so the inventor of claim 2 is matched as Alfa, because D is a reasonable cover of the technical feature D1.

Furthermore, according to an embodiment of the present invention, the matching inventors method may further comprise the following steps of:

If the claim does not match the inventor database and the claim is claim is a depended claim, determining whether a dependent claim depending on the depended claim is matched with at least partial content inside the inventor database;

If the dependent claim is not matched with the inventor database and the other claim depending on the depended claim, determining whether this other claim is matched with at least partial content inside the inventor database; and

If so, matching the inventor with the dependent claim with this other claim depending on the depended claim according to the inventor corresponding the content inside the inventor database.

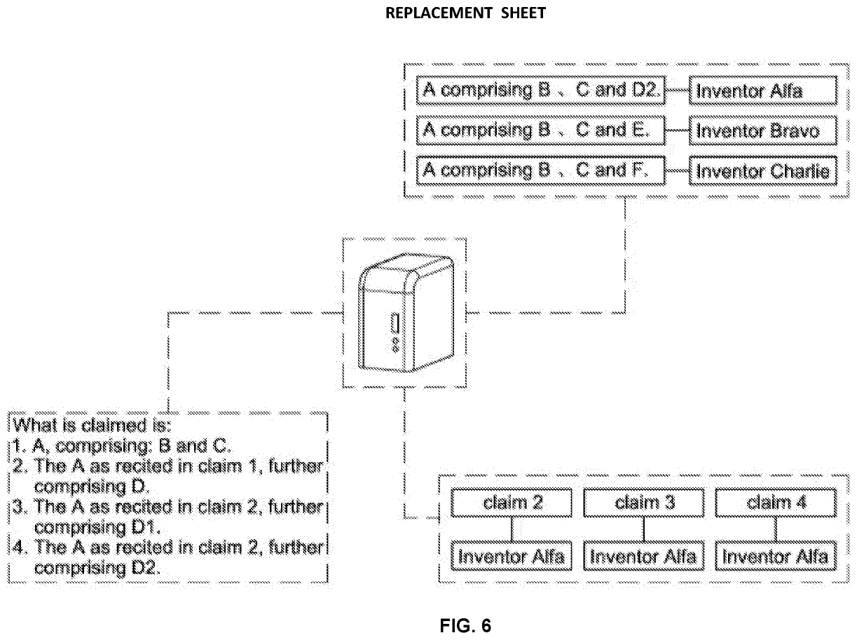

For example, so shown in FIG. 6, What is claimed is:

1. A, comprising: B and C.

2. The A as recited in claim 1, further comprising D.

3. The A as recited in claim 2, further comprising D1.

4. The A as recited in claim 2, further comprising D2.

The D1 claimed in claim 3 can not matched with the inventors database, and the claim 3 is a dependent claim, wherein claim 3 is depending on the claim 2. And feature D1 recited in claim 3 is not matched with the inventors database, then continue to determine claim 4 depending on claim 2 is matched or not. For example, the final confirmation of the inventor of claim 4 is Alfa, so the inventor of claim 2 is matched as Alfa, because D is a reasonable cover of the technical feature D1. The inventor of claim 3 is matched as Alfa, because D1 is a reasonable modification of the technical feature D2.

According to the present invention, as shown in FIG. 7, the present invention provides a matching inventors system 1000, wherein the matching inventors system 1000 comprises an acquiring unit 10, a decision unit 30 and a matching unit 40, wherein the acquiring unit 10 is may be communicably be connected to the decision unit 30, wherein the matching unit 40 is communicatively connected to the decision unit 30. The acquiring unit 10 is configured to obtain a claim, and the decision unit 30 determines whether the claim is matched with at least part of the content inside the inventor database, wherein content inside the inventor database is matched with at least one inventor, wherein when the determination result of the decision unit 30 is affirmative, the matching unit 40 pairs the inventor with the claim according to the content inside the inventor database.

The matching inventors system 1000 further comprises an analysis unit 20, wherein the analysis unit 20 is communicably coupled to the acquiring unit 10 and the decision unit 30 respectively. The analysis unit 20 is used for analyzing the claim obtained of the acquiring unit 10 to provide an analysis. The decision unit 30 determines whether the analysis result is matched with the inventors database.

The analysis unit 20 comprises an extraction module 21 and a translation module 22, wherein the extraction module 21 is configured to extract a discriminated code, wherein the translation module 22 is configured to translate the claims. The extraction module 21 and the translation module 22 are communicably connected to each other.

In the present invention, the extraction module 21 is may be communicably connected to the acquiring unit 10, and the translation module 22 is communicatively connected to the decision unit 30, and the extraction module 21 extracting a discriminated code based on the claim obtained by the acquiring unit 10, and the translation module 22 translates the discriminated code based on the interpretation database and obtains a translation result, and the translation result is sent to the decision unit 30.

Furthermore, the matching inventors system 1000 can comprise a recording unit 50, wherein the recording unit 50 is communicably coupled to the analysis unit 20. The recording unit 50 is for storing a database, such as the translation database, the specialized database or a user's personal database, may also be used to store historical data.

In other embodiments of the present invention, the translation module 22 is may be communicatively connected to the acquiring unit 10, and the extraction module 21 is communicatively connected to the decision unit 30, and the translation module 22 translates the claim obtained by the acquiring unit 10 based on the interpretation database. The translation results are transmitted to the extraction module 21, wherein the extraction module 21 extracting at least one discriminated code from the translation results, and the determining module compares the discriminated code with the inventor database to determine whether the discriminated code is matched with the content inside the inventors database.

Furthermore, the matching inventors system 1000 comprises a setting unit 60, wherein the setting unit 60 comprises a matching setting module 61, a database setting module 62, and an inventor setting module 63. The matching setting module 61 is configured to set a determination rule of the decision unit 30, and the matching setting module 61 is communicably connected to the decision unit 30. The database setting module 62 is communicably coupled to the translation module 22 of the analysis unit 20. The database setting module 62 is configured to set the definition of interpretation database, such as customizing the individualized database or customizing the composition of the interpretation database, such as the weight between the basic database, the individualized database, and the user databases. The inventors setting module 63 is communicatively connected to the matching unit 40, and the inventors setting module 63 is used to set the inventors by user to allow the user to reconfirm or correct the matched result of the matching unit 40.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

What is claimed is:

1. A matching inventors method, comprising steps of:
S1. obtaining a claim;
S2. deciding whether said claim is matched with at least partial content inside at least one inventor database, wherein said at least one inventor database comprises at least one inventor and corresponding content of contribution made by said inventor; and
S3. If so, pairing said corresponding inventor with said claim according to said matched inventor with the contribution inside said at least one inventor database.

2. The method as recited in claim 1, further comprising a step of:
S4. repeating steps of S1 to S3 until all claims are matched with said inventor.

3. The method as recited in claim 1, further comprising a step of:
S5. analyzing the claim to obtain a discriminated code, wherein the step S5 is proceed between the step S1 and step S2, and step S2 is implemented as:
determining whether said discriminated code is matched with at least partial content inside said at least one inventor database, wherein the content inside said at least one inventor database is already paired with said inventor.

4. A matching inventors system, comprising:
an acquiring unit, wherein said acquiring unit is configured to obtain a claim;
a decision unit, wherein after determining whether said claim is matched with at least partial content inside said at least one inventor database, said decision unit generates a pairing result, wherein the content inside said at least one inventor database is paired with said inventor; and
a matching unit, wherein when said the pairing result of said decision unit is affirmative, said matching unit pairs said claim with said inventor according to said matched content inside said at least one inventor database.

5. A matching inventors method, comprising steps of:
I. Obtaining one of claims form a specification;
II. Translating said claim to obtain a discriminated code which presents said claim; and
III. Pairing said discriminated code with at least one inventor preset in at least one to inventors database to determine the contribution of said inventor to said claim.

6. The method as recited in claim 5, wherein the step II comprises step of:
translating said claim to obtain a translation result according to an interpretation database, wherein said interpretation database is a specialized database of patent applications which generally collected the expression of the corresponding interpretation in claims and in specification.

7. The method as recited in claim 5, wherein in the step II, said discriminated code is a distinguishing feature in the body of claim of said claim.

8. The method as recited in claim 6, wherein in the step II, said discriminated code is a distinguishing feature in the body of claim of said claim.

9. The method as recited in claim 5, wherein in the step II, said discriminated code is at least one key word in the body of claim of said claim.

10. The method as recited in claim 6, wherein in the step II, said discriminated code is at least one key word in the body of claim of said claim.

11. The method as recited in claim 5, wherein said at least one inventors database is defined by a user to be predetermined the content of relationships between said inventor and said discriminated code.

12. The method as recited in claim 6, wherein said interpretation database comprises description inside said specification.

13. The method as recited in claim 8, wherein said interpretation database comprises description inside said specification.

14. The method as recited in claim 11, wherein said interpretation database is defined by a user to be predetermined the content inside the interpretation database of expressions of said discriminated code.

15. The method as recited in claim 6, wherein after the step III, when said claim is not paired with said at least one inventors database and if said claim is a dependent claim, pairing said claim with said inventor of the independent claim of said claim.

16. The method as recited in claim 6, wherein after the step III, when said claim is not paired with said at least one inventors database and if said claim is a dependent claim, pairing said claim with said inventor of the depended claim of said claim.

17. The method as recited in claim 6, wherein after the step III, when said claim is not paired with said at least one inventors database and if said claim is an independent claim, pairing said claim with said inventor of the dependent claim of said claim to be further discussed.

18. The method as recited in claim 6, wherein after the step III, when said claim is not paired with said at least one inventors database and if said claim is a depended claim, pairing said claim with said inventor of the dependent claim of said claim to be further discussed.

19. The method as recited in claim 5, wherein after the step III, the paired relationship between said inventor and said claim can be modified and recorded.

20. The method as recited in claim 6, wherein after the step III, the paired relationship between said inventor and said claim can be modified and recorded.
